(19) United States
(12) Patent Application Publication
(10) Pub. No.: US 2007/0271472 A1
(43) Pub. Date: Nov. 22, 2007

(54) Secure Portable File Storage Device

(76) Inventor: Amiram Grynberg, Neve-Efrayim Monson (IL)

Correspondence Address: AMIRAM GRYNBERG, 24 RIMON ST, NEVE EFRAYIM MONSON, 60190, omitted

(21) Appl. No.: 11/748,507

(22) Filed: May 15, 2007

Related U.S. Application Data
(60) Provisional application No. 60/767,531, filed on May 21, 2006.

(51) Int. Cl. G06F 12/14

(52) U.S. Cl. 713/193

(57) ABSTRACT

A SPFSD comprising content entities stored as sets of storage blocks accessible to block input/output operations, requested by a requestor external to said SPFSD, wherein a storage block is further associated with security attributes not accessible to non authenticated requests and wherein an operation on said block is subject to access permissions determined by said attributes.

### CROSS REFERENCE TO RELATED APPLICATIONS

Provisional Application Ser. No. 60/767531, the benefit of which is hereby claimed under 35 U.S.C. .sctn. 119 (e), and wherein said provisional application is further incorporated herein by reference.

### BACKGROUND OF THE INVENTION

The use of portable file storage devices (PFSD) is proliferating. Such devices take on many shapes: A USB flash drive (UFD), digital camera, cell phone, memory cards, portable computing devices etc.

What is common to all these devices is that their content can be accessed, as file system, by a connected computing device.

U.S. Pat. No. 5,404,485 discloses the implementation of flash memory as a block storage device (file system format). As a block device, a PFSD serves as a disk replacement whereby the responsibility for formatting and managing the content resides fully within an attached computing device and its operating system.

Such devices are used, quite often, to share content between persons and/or to transfer data from one computing system to another. Lately, such devices have been enhanced to provide for automatic launching of programs stored on these devices (U3 initiative and others).

One of the problems with such portable storage is that there is virtually no write control mechanism to help keep the contents of such devices safe. If a PFSD is connected with a hostile computer, for example, such a computer could erase the contents of the PFSD or infect it with viruses. Similarly, when such a device is shared with other persons, they may (inadvertently) erase some important information residing on such a device.

On the other hand, owners of such PFSDs would like to be able to use their device even with an unknown hosting computer, but in a safe way.

If a PFSD is infected by a virus, while it is connected with an infected computer, it may later infect other computers when it is connected with such computers. Similarly, if a PFSD is connected with a hostile computer, such a computer may install spyware on the PFSD.

Let us examine some typical (but not exhaustive) use cases of PFSD.

Trusted host. A person who usually owns and controls the device operates the device connected to a trusted computer. The user and all applications executing on the host computer should have full privileges to the device.

Non-trusted host, case 1. The device is accessed in read-only mode. A device appearing as a CD-ROM.

Non-trusted host, case 2. Most content is designated as read-only. However, some trusted applications should be able to write data to specified files or folders which they manage. Example: A password manger application should be able to save passwords to its own data files.

Non-trusted host, case 3. The owner user wants to upload and copy image files from a camera device to the PFSD via a host computer. If said user does not have a trusted application which can do it, then the operating system should be given write access privileges to a subset of folders. However, the OS (or any application running on the host) should not be able to install executable files on the device.

Installing an executable file on a PFSD by a hostile application can be carried out through several methods. A first method is to simply copy the file, creating a new directory entry on the device. The second method is to write the file over an existing executable file. The third method is to write the file as a data file and then rename it to an executable file.

Authenticating a user to the device before the contents of a PFSD are made available is well known in the art. However, this is an all or nothing approach to accessing the contents of the device and once a device is “opened up”, hostile software can access the device for whatever malicious purpose it wants to.

Furthermore, even authenticating a user to provide access to a specific file (which is not disclosed in prior art), does not solve the problem, for the same reason cited above.

One approach to solving such a problem is to make the device or some files on the device read-only. However the only known mechanism to provide such protection is either formatting the whole drive as a CD-ROM, DVD or other read-only format, or changing the read attribute of all files on the drive.

Formatting a PFSD as a CD-ROM will do the trick, but it does not provide for an easy update method by an authorized owner of the device. Furthermore, it does not allow any application that needs to store its data on the device selectively, to do so using such a format.

Changing the recorded attributes of a subset, or all files, to read-only is not really a solution since OS or applications with access to the device can change them back to read-write.

An alternative approach is to change the controller of a PFSD so that it exposes a file server interface instead of a block device interface to the OS of the hosting computer or to another device. Such an arrangement is disclosed by patent application 20040073727. However, 20040073727 does not disclose any access control mechanism. Furthermore, since 20040073727 promotes a dual system wherein a device can expose both a block interface and a files system interface to the same data, it is apparent that access control s not an intended result since an OS can overwrite the formatted file system blocks directly and thus make any intended access control useless.

Implementing and using access control mechanisms as they are known in popular OS is an overkill for a device resident firmware. Managing such permissions is an administrative task not suitable for small devices or to consumers who handle such devices.

Patent application 20040157638 discloses a telephone device wherein access privileges to at least part of its storage are changed when said device is physically attached to a host or another device. However, said change does not provide the granularity we need to address the stated use cases of the present invention.

Patent application 20070056042 discloses an alternative solution. A PFSD is divided into “partitions” which may be either public or private. A public partition is accessible to an OS which a private partition is accessible only to processes, executing on a host machine, which are authorized to access said partition. Furthermore, each file within a partition can be encrypted wherein an encryption key is known only to selected processes, thus providing additional read protection. However, partitioning a device is a destructive process and it cannot be used to grant or deny the whole range of access permissions to particular files or folders.

Therefore, it would be advantageous to have a PFSD and methods thereof that provide for a selective write protection of the content stored on such a device whereby some content will be protected while other will not and whereby authorized applications would have restricted access to some content and unrestricted access to other content and whereby authorized users or applications could change such protection when needed without reformatting said device.

It is also advantageous to dynamically being able to modify the format exposed by a PFSD wherein authenticated application are exposed to a read-write format like a regular disk drive while non authenticated requests are exposed to a CD-LIKE format.

### SUMMARY OF THE INVENTION

The current invention describes a secure PFSD device (SPFSD) and methods for controlling access to files residing on said device.

When a SPFSD exposes its interface as a block device, access to files is preferably managed by extending its FAT and adding fields to the extended FAT. Such fields may include content descriptors and security ACL.

A SPFSD implementing methods for mapping access privileges to block operations into file access permissions is disclosed.

In accordance with the current invention, modifying or adding executable data on a SPFSD is subject to special privileges.

Further, a SPFSD which dynamically embeds security data within data being read is described.

### BRIEF DESCRIPTIONS OF THE DRAWINGS

FIG. 1 describes how to determine the ACL of an entry in a folder block.

FIG. 2 is a flowchart describing access control logic for reading a block.

FIG. 3 is a flowchart describing access control logic for writing a free block or a file block.

FIG. 4 is a flowchart describing access control logic for writing to a folder (directory) block.

FIG. 5 is a flowchart describing access control logic for writing to a FAT block.

FIG. 6 is a diagram showing how a security map is implemented on a block device.

### DETAILS OF THE INVENTION

The present invention is of a secure portable file storage device SPFSD wherein access privileges to all or part of files and folders stored on such a device are granted by said SPFSD in response to authenticated and non authenticated requests received from applications executing on a hosting computer or on another device.

A SPFSD may be a block device which exposes an interface to an external hosting computer or another device, wherein said interface is responsive to commands like: read data block and write data block by an external application executing on the hosting device. In such a device, the formatting and use of the stored data is controlled by an external application.

Alternatively, a SPFSD is a file server device which exposes a file system interface and protocol responsive to file system commands like ‘open file’, ‘read’, ‘rename’ etc. In such a device, the formatting, reading and writing of data blocks is controlled by the device, in response to external file system commands.

For maximum compatibility, A SPFSD may implement both interfaces thus providing for more flexibility. However, external programs should not be able to modify its access control settings unless they use authenticated requests.

Authenticating a user to a SPFSD is a process which is well known in the art. A user can enter a password (to an application or directly to a device having input means) or use other techniques. Once a device verifies authentication credentials, it “opens up” to a user, said user and the OS or applications executing on a host computer get the same privileges granted to said user. Patent application 20040103288 discloses a secure device the access to which can be “opened up” by a password accepted from a user.

To facilitate a selective access by applications, to the content of a SPFSD, such applications need to authenticate so that they can prove to be trusted.

There are several methods that can be used for authenticating an application. Such methods are well known in the art of cryptography. Three methods are described herein.

A first method is code signing the program file of such applications. However, a SPFSD has no access to and no knowledge of the application program file. A possible solution is to have a proxy program which is trusted by the SPFSD which will verify contending applications.

A second method, which can also be used by said proxy program, is to prove to a SSPFD that the application knows a secret shared between said application and said SSPFD. There are several techniques known in the art. Executing a zero knowledge password proof method is one possible method.

Alternatively, a SPFSD can store the public key of a key-pair where the corresponding private key is securely available to said trusted application. A SPFSD can challenge a contending application and receive knowledge proof of the private key by way of a returned encrypted challenge.

The reader will appreciate that there are numerous other methods which are known in the art of cryptography to authenticate a request.

Thus, an authenticated request is a request for an operation originated by an application which previously proved its identity to a SPFSD (session). Alternatively, each request can prove said identity independently (session-less).

Privileges are associated with a requestor and are related to content entities on a SPFSD.

Following is a detailed presentation of a preferred embodiment of the present invention. It is understood that many implementations can be derived by those skilled in the art of cryptography and system programming.

Content entities are defined as logical file system components, not the physical storage or logical data blocks onto which such entities are mapped. The root of the file system is a root content entity and privileges to subordinate entities are inherited by them from a parent entity unless they are specifically expanded or restricted for some subordinate entities by an authorized requester.

There are two classes of requesters. The first class is an operating system generated request, assumed to be unauthenticated request. With a request of this class, any application running on the host computer can issue requests that will have privileges equal to the user who logged in to the host computer. Meaning, that once a device “opens up” to a user, it also opens up to all unauthenticated applications running on the host.

The second class is a request originated by an authenticated application running on the host computer.

When referring to ‘requested operations’ and their associated privileges, we preferably mean the following operations: read, control, add, write, write-executable, rename, rename-to-executable and delete. These privileges are not the typical ones you would find in operating systems (OS) because they are geared to resolve the use cases listed in the background section.

Read privilege—being able to read a content entity from a device.

Control privileges—being able to change the privileges of requesters to a content entity.

Add—being able to add a sub-directory content entity or file entity to an exiting directory content entity. The requestor may get all privileges to the new entity.

Write privilege—being able to write a content entity (other than executable content) to a device.

Write-executable privilege—being able to write a content entity that is part of an executable file, (a file that can be invoked to run as a program), Executable files are usually classified as such by the suffix of their file name.

Rename privilege—being able to modify a name of a file or directory content entities but not to change it from a non-executable to an executable content.

Rename-to-executable—being able to modify a non-executable file name content entity to an executable file name.

Delete—being able to delete content entity.

Implementing an access control system, as described above, on a block device wherein the OS has full access to all the blocks is not trivial, since the OS or other rogue applications can modify any information which is mapped to a file system format on a regular PFSD.

It is therefore necessary to enhance the internal structure of a prior art PFSD to facilitate selective access control.

As an example for embodiment of such a mechanism, we shall describe the implementation details for a SPFSD formatted to the specs of FAT(32, 16,12). A FAT format provides for accessing information by clusters. Each cluster is represented by a single entry in a file allocation table (FAT).

Please note that unlike simple controllers which provide for block storage, the controller in a PFSD which is the subject of the present invention must understand the structure of a file system format implemented by the PFSD.

Master Switch.

To facilitate ease of use, it is advantageous to have a master logical switch (security state) that governs the behavior of a PFSD. When said switch is in the “secured” position, access control privileges are checked before any operation is allowed. When this switch is in a non-secured position, all operations are allowed with no security checks (This use case is valid when using a PFSD in a trusted environment). It is evident that other rules can be established if needed. Setting the switch may require ‘control privilege’ to the root of the PFSD.

In a preferred embodiment of a master switch, it would have four states: hidden, read-only, secured, non-secured. Hidden means that access to content is denied. Read-only means that contents can be read but not written, Secured means that access control is determined by granular access control (per file) as described below, if one exists, and unsecured means that all operations are wide open to application requests. It should be clear that this concept can be played in a variety of ways to combine a master switch with more granular ACL controlled privileges.

In accordance with the above preferred configuration, a PFSD is, by default, in a hidden state. A user sends an authenticated request to the device via a master login application, selecting a desired access state: read-only, secured or unsecured.

Ideally, a PFSD is “opened” by a user in read-only mode, activating a security application on the host computing device (anti-virus etc.). Once active, said security application can send an authenticated request to “open up” the device to other applications for unsecured access or secured access depending on preset configuration.

A Master Switch can be implemented by selectively accepting authenticated requests with ‘control’ privileges from external applications.

Alternatively, a Master Switch is a logical switch built into a PFSD. A logical switch is one which is implemented by logic implemented by a PFSD and is responsive to input means securely accessible to PFSD such as touch screen or other know means.

Implementing granular access control.

The description below is of a preferred implementation however, other implementations are possible and can easily derived from the principles disclosed by the present invention, by those skilled in the art of file system design.

For each entry in the FAT table there is added an extended FAT entry that extends the original entry but is not accessible to the hosting OS. Such an extension can be implemented by a separate table.

Each extended FAT entry may hold at least two fields. A first field defines the type of information in said entry (folder, file, executable). A second field holds an index into an access control list (ACL). The ACL holds access records wherein each record maintains access privileges of a single requestor (including unauthenticated requesters). The records are singly linked to create chains or lists.

Privileges which are related to a folder entry (a file or sub-folder within said folder) may be saved in the extended FAT entry related to the first cluster of said entry.

Unfortunately, OS do not tell block devices what they are about to do. Unlike when implemented as a file server, a PFSD implementing a block device only receives a read/write request of data blocks. It is not aware if a new file is created or modified or any other file related operation.

The PFSD is therefore required to efficiently map such low level requests to the file system format for the purpose of checking access privileges. Thus, in accordance with a preferred embodiment of the present invention, a PFSD will use the following algorithm to map such operations:

Adding a new requestor or modifying privileges of existing requesters. A requester, which has ‘control’ privileges to a folder or file, is authorized to add or modify privileges of other requesters to the folder or file.

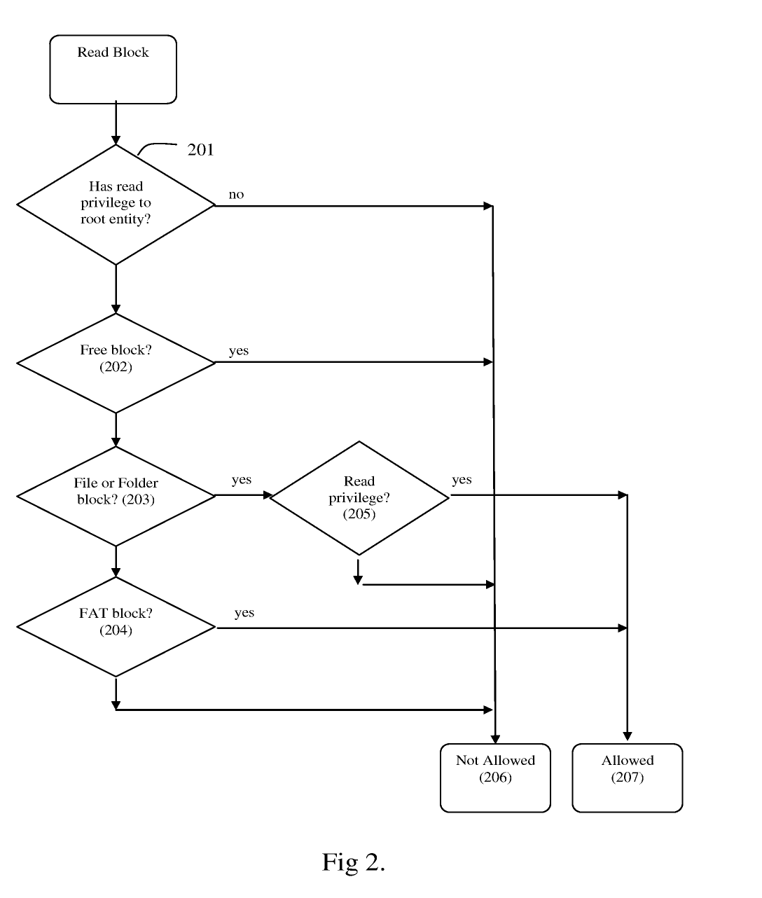

FIG. 2 is a flowchart describing access control logic for reading a block.

In 201, if a requestor does not have read privilege to the root of the file system, then said requestor cannot read any content (206), rendering the device as an empty device.

In 202, if the block is free—do not allow read access (to prevent readout of deleted files).

In 203, if this is a file or folder block, allow the operation (207) only if said requestor has read access to these content entities.

In 204 if this is a FAT block, allow read access.

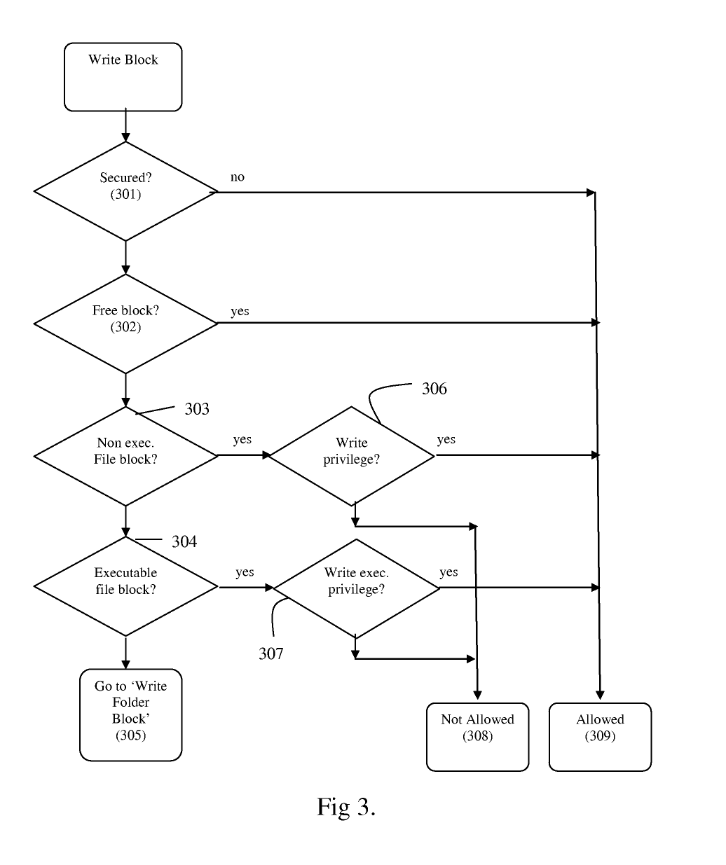

FIG. 3 is a flowchart describing access control logic for writing a free block or a file block.

In 301, if the master switch is not set to ‘secured’, allow operation (309).

In 302, write to a free block—allow the operation since such writing does not (yet) create accessible content entity.

In 303, Writing to a file block—If the requestor is authorized to “write” to the block (306) and the block is not marked as executable, allow the operation.

In 304, writing to an executable file block—If the requestor is authorized to “write-executable” to the block (307), allow the operation.

Handling folder blocks.

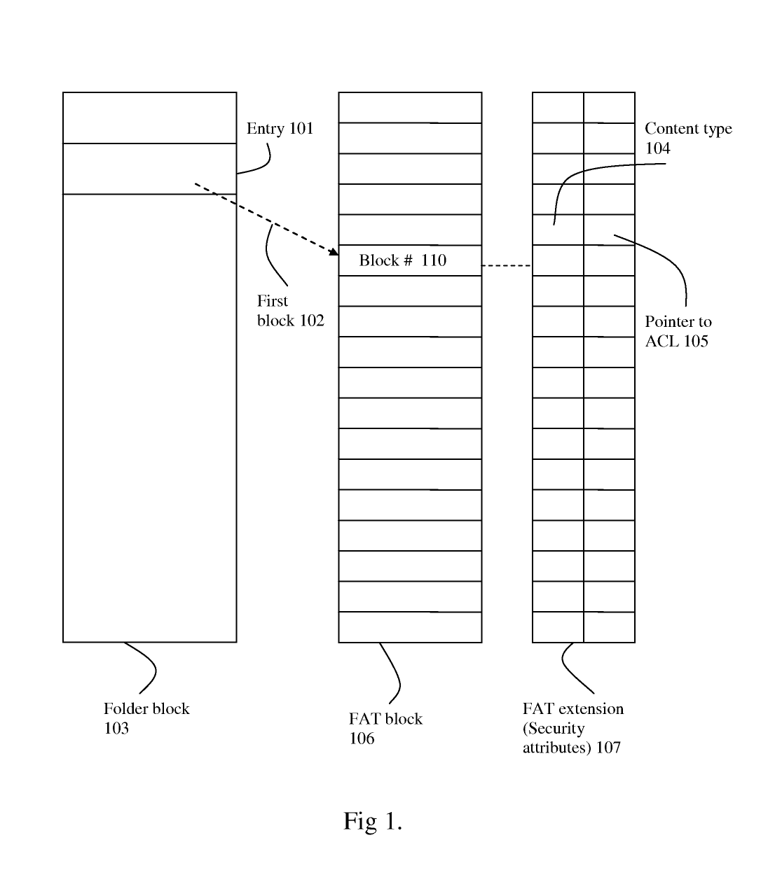

FIG. 1 describes how to determine the ACL of an entry in a folder block.

Privileges to a folder entry 101 in folder block 103, representing content entity, are determined by the security attributes 104 and 105, associated with the extended FAT entry 107, mapped to the first block 110 pointed to by said entry 101.

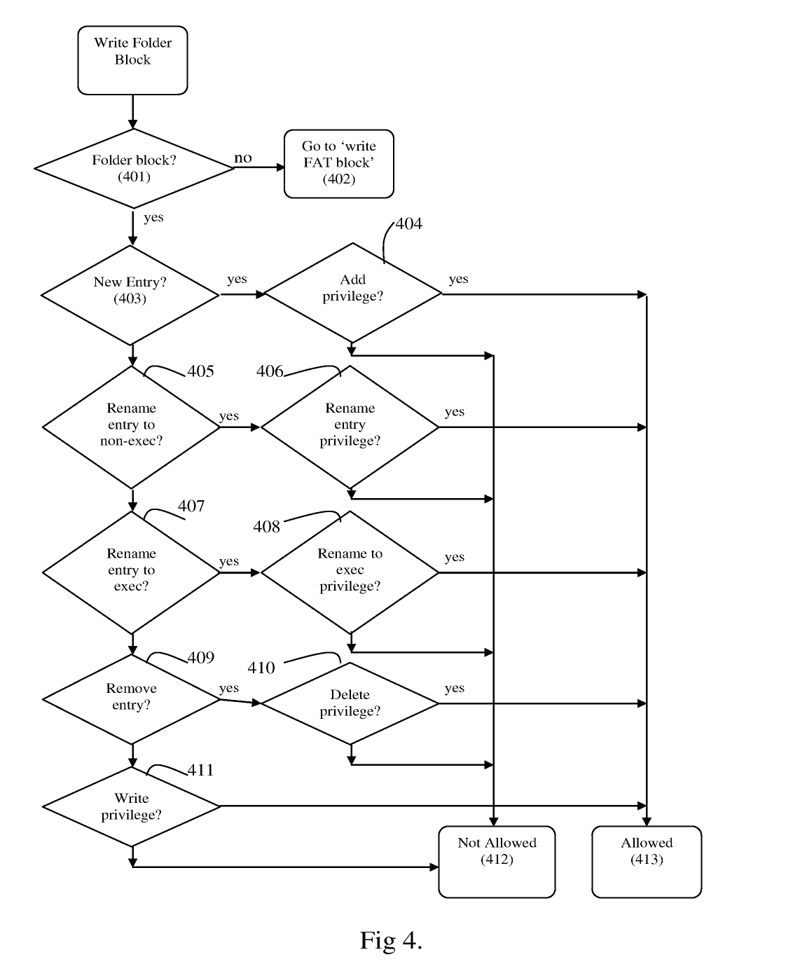

FIG. 4 is a flowchart describing access control logic for writing to a folder (directory) block.

Compare the new block with the existing one.

### In 403, if the difference is that a new entry is added to the (folder) block, and the requestor is authorized to

### “Add” to the folder 404, allow the operation 413.

### In 405, if the difference is that an entry has a modified file name (but the new name is not an executable, or the new name is executable and the previous one was also) and the requestor is authorized to “rename” the entry 406, allow the operation.

### In 407, if the difference is that an entry has a modified file name (and the new name is an executable and the previous name was not) and the requestor is authorized to “rename-to-executable” 408, allow the operation.

### In 409, if the difference is that an entry is removed and the requestor is authorized to ‘delete’ 410, allow the operation.

### If this is not a rename, add or delete, then allow writing to a folder block only if the requestor has write privilege to that block 411.

After an entry in a folder content entity is modified, a PFSD controller should verify the related extended FAT entries of the FAT chain to insure that they use the correct ACL. Furthermore, since the access rules cited above may lead to orphan FAT entries, cleanup is required periodically. This can be maintained by standard OS routines on a trusted computer.

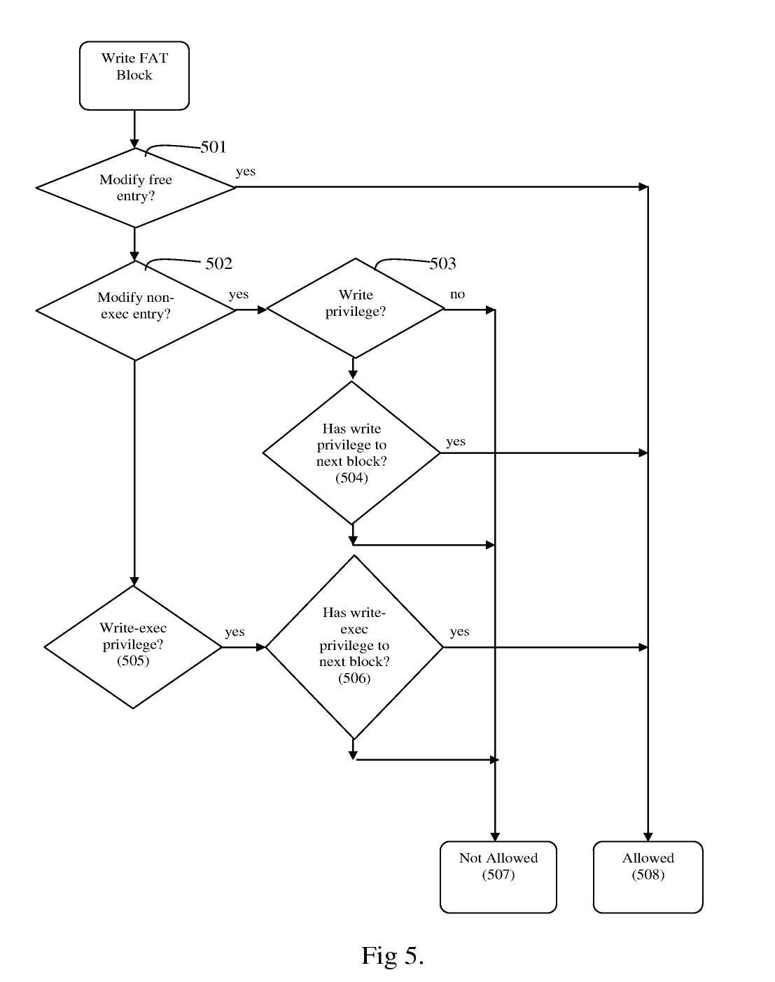

FIG. 5 is a flowchart describing access control logic for writing to a FAT block. Writing to a FAT block creates a new content entity, extends the size of an existing content entity, re-organize clusters of exiting content entity or trim a content entity and free unused entries. The first step is to compare the new block to the existing one. If the new block modifies an existing entry, check the associated extended FAT of such entry.

### In 501, if the existing entry is a ‘free’ entry, allow the operation 508.

In 502, if the modified entry is not marked as “executable” and the requestor is authorized to “write” to the associated content entry 503, allow the operation provided that the requestor has similar privileges to the next block pointed to by the current block 504. (to prevent spoofing by cross linking files).
In 505, if the modified entry is marked as executable and the requestor is authorized to “write-executable” to the associated content entity, allow the operation provided that the requestor has similar privileges to the next block pointed to by the current block 506. (to prevent spoofing by cross linking files).

Alternate file system formats.

An alternative approach to implementing a SPFSD is to dynamically expose one of two alternate formats. A first format would be a read-only format like the once exposed by a CD-ROM or DVD. The second format would be a regular disk format (FAT based or other). By default, a read-only format is exposed. However, when an authorized application authenticates itself, a read-write format is exposed.

Such a device uses a single data store, but its controller will dynamically map all requests to virtual blocks of data corresponding to the structure of the file format being exposed.

While being less granular in controlling access, this alternative approach provides for ease of management and adaptation.

Thus, in accordance with an alternative embodiment of the present invention, there is a SPFSD having permanent, re-writeable storage means with a first data store format, controller means and interface means communicative with external requesters wherein said controller, being responsive to requests received via said interface means.

As a request is received through interface means, the request is authenticated. If authentication succeeds, the request is routed to a logic which translates block access request, according to a first format regiment (read-write) into internal block access. If authentication fails, or does not exist, said request is translated according to a second regiment matching a read-only format.

Thus, forming a block of data to be returned to a requester, is a dynamic process created “in memory” on the fly. Similarly, accepting a block of data decomposing it into internal storage is performed on the fly in accordance with the current format.

The present invention should not be confused with a similar mechanism previously disclosed as means to internally store data in a PFSD. In a prior art, a single format is mapped from a logical format to an internal format which matches the physical characteristics of a PFSD. In the current invention, multiple logical formats are available for accessing the same internal format wherein a format is determined by an authentication process. Patent application 20040157638 discloses a concept of file system emulators which “emulate a same set of data as multiple file systems” to different hosts. However, such emulation offers to use multiple FAT tables and is not in response to the authentication status requests.

Embedding shared secrets.

As discussed earlier, there are many ways available for authenticating a request made by an external application to a SPFSD. However, all of them share the same problem: they rely on some secret data embedded hidden within or by the external application. It can be a shared secret or a private key of a key-pair system. Thus, an off line attack on such applications, could eventually yield the secret to an attacker.

This argument is especially true if all copies of a particular application and available to the public contain the same secret.

Embedding secret data within an application (data or code) involves a set of at least two parameters: where to embed a secret within a particular application and what is the value of the embedded secret. Both of these parameters are considered to be a secret. It is also advantageous to spread an embedded secret so that it is not located in a single offset within an application file. This can be compounded even further by embedding executable code within said application to access said secret.

To make it more difficult for an attacker to retrieve an embedded secret, by comparing one copy of the application with another copy, it is advantageous to embed random “noise” data within an application.

It is therefore convenient to regard the embedded secret data as a security map comprising a table of offsets (relative to an application file image) and a value stored in each offset.

Copy-protection techniques which embed different codes into different copies of the same application are well known. However, these techniques do not solve the problem of using said embedded code to facilitate secure authentication to a PFSD.

If an application is stored on a PFSD, prior to it being read into the memory of a hosting computer to be executed, it is possible to involve the PFSD in establishing a more secure way for storing secret data within said application.

Thus, in a first embodiment of the current invention, first, an application executing under a trusted environment, sends a request to a PFSD providing it with a security map. Said PFSD stores said security map and associates it with an application file on said PFSD.

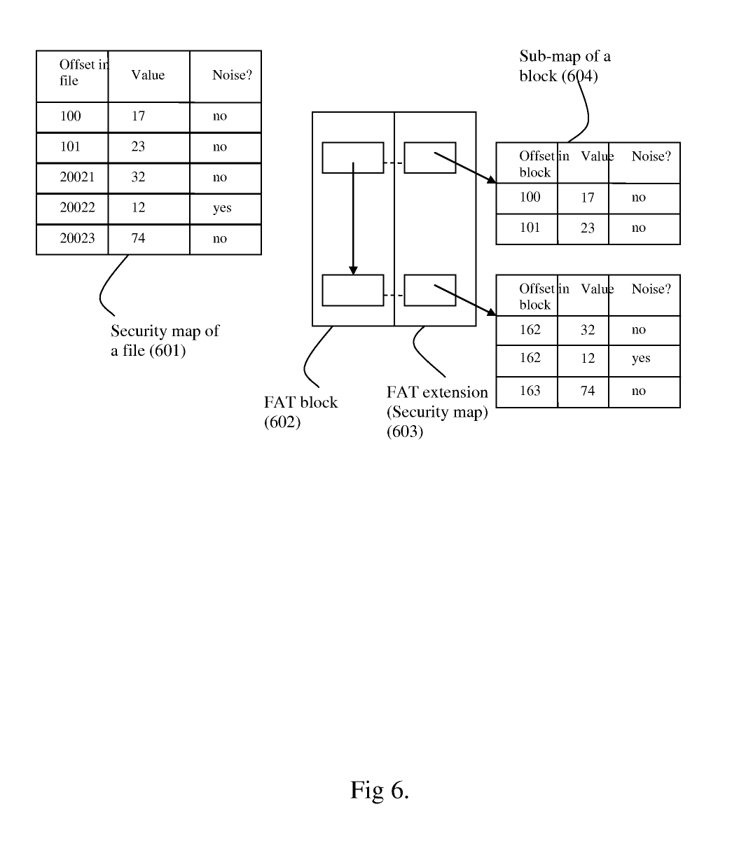

FIG. 6 describes one method of implementing a security map related to a file. A security map is broken up into sub-maps, each associated with a data block making out said file. Each sub-map is then referred to by a field in an extended FAT entry.

When an application file is subsequently read from a PFSD, and such a file has an associated security map, data sent back by a PFSD to the host reading the file, is dynamically modified using said security map to embed shared secret data and noise data.

Although security maps 601 and 604 show a pre-set value for each modified entry, in practice, it may be advantageous to use random data. So, that each time a program file is read, the secret will be different. If random data is used, a PFSD saves a copy of that data related to a shared secret so that it can be used for later authentication of requests received from said application.

It should be clear that other implementations are possible and can be readily derived from this invention by those skilled in the art.

What is claimed is:

1. A secure portable file system device (SPFSD) comprising:
Content entity stored as a set of blocks within a block based file system, at least partially accessible to non authenticated block input/output requests originating external to said SPFSD; and
Security attributes linked to said blocks; and
Requestor authentication means responsive to determine access privileges for carrying out an operation on said blocks from an external requester; and
Access control means, controlling access to said blocks, as a function of said attributes and said privileges.

2. The device of claim 1 wherein said security attributes include content type attributes.

3. The device of claim 1 wherein said security attributes include ACL.

4. The device of claim 1 further comprising the means for:
comparing entries in a new block submitted by a write operation, with stored data;
mapping differences of said comparison to security attributes associated with at least one data block;
determining if said operation is allowed from said mapping.

5. The device of claim 1 wherein said content entity is part of an executable content and said operation is ‘write-executable’.

6. The device of claim 1 wherein said content entity is not part of an executable content and said operation is ‘rename-to-executable’.

7. The device of claim 1 wherein a requestor is automatically granted all privileges to a new content entity it creates on said device.

8. The device of claim 1, further having multiple security states, wherein at least a first state expands privileges, granted to requests, relative to default privileges and a second state enforcing default privileges.

9. The device of claim 1, further having multiple security states, wherein at least a first state restricts privileges, granted to requests, relative to default privileges, and a second state enforcing default privileges.

10. A SPFSD having at least two security states, wherein a first state is a read-only state and switching from one state to a less restrictive one is enabled by a Master Switch.

11. The device of claim 10 wherein said Master Switch is implemented by selectively accepting authenticated requests from outside said device.

12. The device of claim 10 wherein said Master Switch is implemented by selectively accepting signals from input means securely accessible to said device.

13. The device of claim 10 having at least three security states wherein a first default state is most restrictive and the other states are less restrictive.

14. The device of claim 13 wherein a first state is hidden, a second state is read-only and third state is unrestricted access and said Master Switch is implemented by an external monitoring application after said application starts monitoring write requests to said device.

15. The device of claim 14 wherein read-only state is implemented by exposing a read-only file system format and the other state is implemented by exposing a writeable file system format, both referring to the same underlying data.

16. A SPFSD, selectively modifying data being read from said device by embedding authentication data within said data being read in accordance with a security map associated with said data being read.

17. The device of claim 16 further embedding noise data within said data being read.

18. The device of claim 16 wherein said data being read is an executable data.
